(19) United States
(12) Patent Application Publication
(10) Pub. No.: US 2011/0279855 A1
(43) Pub. Date: Nov. 17, 2011

(54) RETRIEVAL SYSTEM, IMAGE FORMING APPARATUS, AND RECORDING MEDIUM

(75) Inventors: Mitsuharu NAGAI, Amagasaki-shi (JP); Hidetaka Iwai, Itami-shi (JP); Kazuo Inui, Itami-shi (JP); Nobuhiro Mishima, Yodogawa-ku (JP)

(73) Assignee: Konica Minolta Business Technologies, Inc., Chiyoda-ku (JP)

(21) Appl. No.: 13/101,170

(22) Filed: May 5, 2011

(30) Foreign Application Priority Data
May 11, 2010 (JP) 2010-108901

(51) Int. Cl. G06F 15/00

(52) U.S. Cl. 358/1.15

(57) ABSTRACT

A retrieval system comprises an image forming apparatus having a box which is a data storage area and a terminal device for retrieval, which is connected to the image forming apparatus via a network, and retrieves information stored in the image forming apparatus. The image forming apparatus has a storage part for storing bookmark information including list information of item names of items in an electronic document file stored in the box and a transmission part for transmitting the bookmark information to the terminal device.

This application is based on Japanese Patent Application No. 2010-108901 filed on May 11, 2010, the contents of which are hereby incorporated by reference.

### BACKGROUND OF THE INVENTION

1. Field of the Invention

The present invention relates to a retrieval system for retrieving information stored in an image forming apparatus and a technique relevant thereto.

2. Description of the Background Art

With a development of network technology and the like, some of image forming apparatuses such as MFPs (Multi Function Peripherals) each have a storage part such as a hard disk. These apparatuses store various data files such as image data, document data, and the like in a predetermined storage area (referred to as a “box” or the like) inside the hard disk.

In order to effectively use information in such a box, desired is a technique for retrieving information in the box.

As the technique for retrieving information stored in the image forming apparatus, a technique is disclosed in, for example, Japanese Patent Application Laid Open Gazette No. 2006-163986 (Patent Document 1).

In Patent Document 1, shown is a technique in which characters included in image data stored in an image forming apparatus are extracted and information retrieval is performed by using character codes of the extracted characters.

In the technique shown in Patent Document 1, however, character retrieval using a keyword or the like can be performed, but not always efficiently. Even if the technique of Patent Document 1 is used, for example, it is difficult to roughly know what information is present in the image forming apparatus.

### SUMMARY OF THE INVENTION

It is an object of the present invention to provide a retrieval system capable of efficiently retrieving information stored in an image forming apparatus and a technique relevant thereto.

The present invention is intended for a retrieval system for retrieving information stored in an image forming apparatus. According to a first aspect of the present invention, the retrieval system comprises an image forming apparatus having a box which is a data storage area and a terminal device for retrieval, which is connected to the image forming apparatus via a network, and in the retrieval system of the present invention, the image forming apparatus has a storage part for storing bookmark information including list information of item names of items in an electronic document file stored in the box and a transmission part for transmitting the bookmark information to the terminal device.

The present invention is also intended for an image forming apparatus connected to an external device for retrieval via a network. According to a second aspect of the present invention, the image forming apparatus comprises a storage part having a box which is a storage area for an electronic document file, a generation part for generating bookmark information including list information of item names of items in the electronic document file, and a transmission part for transmitting the bookmark information to the external device.

The present invention is further intended for a non-transitory computer-readable recording medium for recording a computer program to be executed by a computer embedded in an image forming apparatus. According to a third aspect of the present invention, the computer program causes the computer to perform the steps of a) generating bookmark information including list information of item names of items in an electronic document file stored in a box which is a storage area inside the image forming apparatus and b) transmitting the bookmark information to an external device for retrieval via a network.

The present invention is intended again for a retrieval system for retrieving information stored in an image forming apparatus. According to a fourth aspect of the present invention, the retrieval system comprises an image forming apparatus which stores information in a box which is a storage area thereinside and a terminal device for retrieval, which is connected to the image forming apparatus via a network, and in the retrieval system of the present invention, the image forming apparatus has an attribute information acquisition part for acquiring attribute information of each file in the box and a transmission part for transmitting the attribute information of the each file to the terminal device in response to a transmission instruction from the terminal device, and the terminal device has an input part for receiving a specification input of a specific attribute which is an attribute of a file to be extracted and a retrieval part for retrieving a file having the specific attribute among a plurality of files in the box on the basis of the attribute information transmitted from the image forming apparatus and the specific attribute inputted by the input part.

According to a fifth aspect of the present invention, the retrieval system comprises a plurality of image forming apparatuses and a terminal device for retrieval, which is connected to the plurality of image forming apparatuses via a network, and in the retrieval system of the present invention, the plurality of image forming apparatuses each have a storage part having a box which is a file storage area, an attribute information acquisition part for acquiring attribute information of each file in the box, and a transmission part for transmitting the attribute information of the each file to the terminal device in response to a transmission instruction from the terminal device, and the terminal device has an input part for receiving a specification input of a specific attribute which is an attribute of a file to be extracted and a retrieval part for retrieving a file having the specific attribute among a plurality of files in the box on the basis of the attribute information transmitted from each of the plurality of image forming apparatuses and the specific attribute inputted by the input part.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 are conceptual diagrams each showing an outline of a retrieval system in accordance with a first preferred embodiment;

FIG. 3 is a block diagram schematically showing a constitution of an MFP;

FIG. 4 is a flowchart showing an operation for generating an integrated link information file;

FIG. 5 is a view showing an exemplary specification of a link target of each item;

FIG. 6 is a view showing a display of the integrated link information file;

FIG. 7 is a view showing a display of a file which is a link target;

FIG. 8 is a view showing an item selection screen;

FIG. 9 is a view showing a state where the file which is the link target is displayed in accordance with a result of selection in the item selection screen;

FIG. 10 is a view showing a system configuration in accordance with a variation of the first preferred embodiment;

FIG. 11 is a conceptual diagram showing an outline of a retrieval system in accordance with a second preferred embodiment;

FIG. 12 is a view schematically showing a constitution of an MFP (image forming apparatus) in accordance with the second preferred embodiment;

FIG. 13 is a view showing a search dialog;

FIG. 14 is a view showing a result of a search through a single MFP;

FIG. 15 is a conceptual diagram illustrating a search through a plurality of MFPs; and

FIG. 16 is a view showing a result of the search through the plurality of MFPs.

### DESCRIPTION OF THE PREFERRED EMBODIMENTS

Hereinafter, the preferred embodiments of the present invention will be discussed with reference to the accompanying drawings.

### 1. The First Preferred Embodiment

### 1-1. Outline

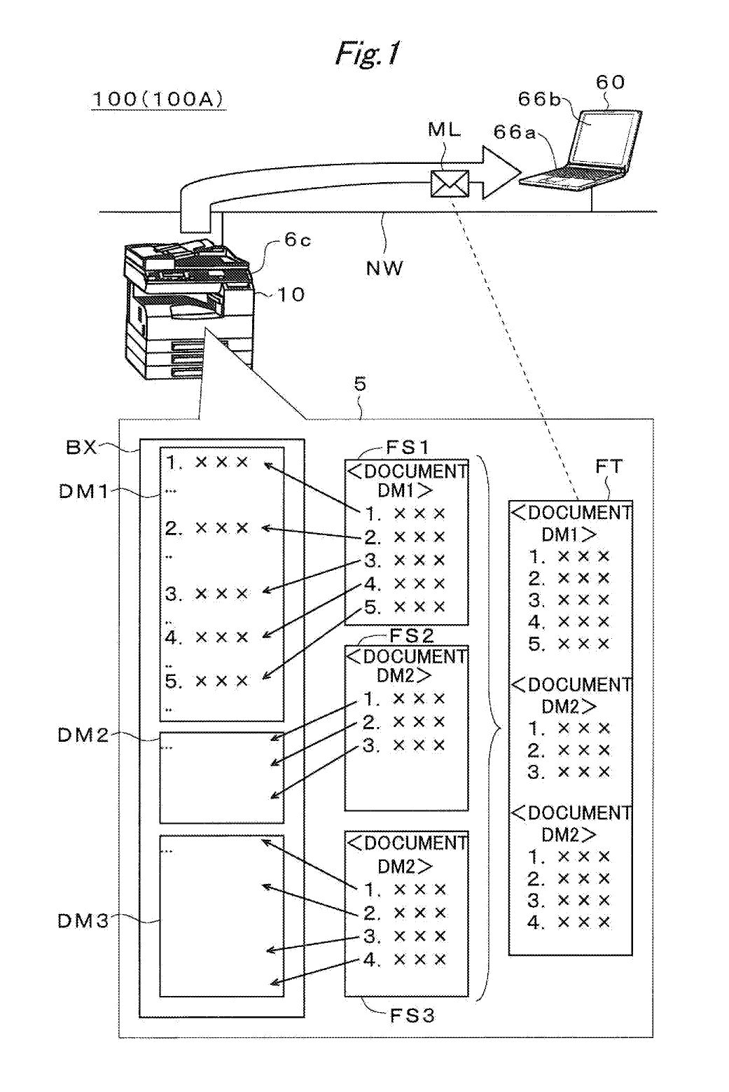

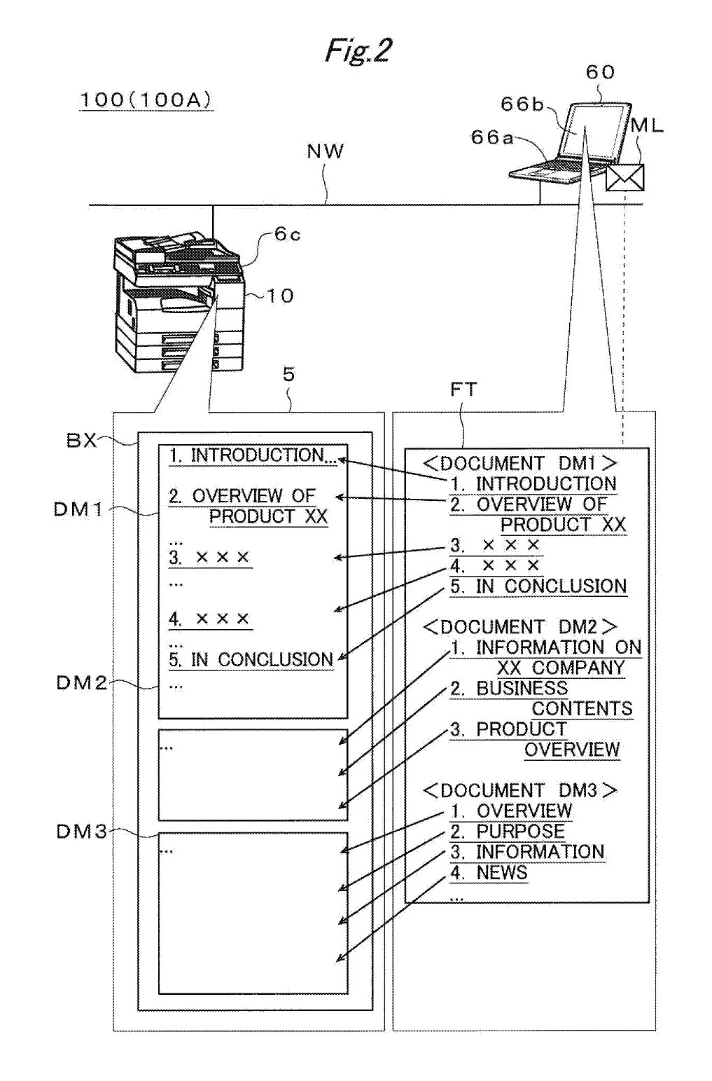

FIGS. 1 and 2 are conceptual diagrams each showing an outline of a retrieval system 100 (referred to also as 100A) in accordance with the first preferred embodiment. As shown in FIGS. 1 and 2, the retrieval system 100 comprises an MFP (Multi Function Peripheral) 10 and a computer 60. The MFP 10 and the computer 60 are connected to each other via a network NW, and network communication can be established therebetween. The network NW includes various networks such as a LAN (Local Area Network), a WAN (Wide Area Network), the internet, and the like. The connection to the network NW may be wired or wireless.

The MFP 10 has a function of accumulating electronic document files DMi. In response to an operation input from the computer 60, the retrieval system 100 can retrieve information stored in the MFP 10. In more detail, it is possible to retrieve information included in the electronic document files (data files) DMi stored in a box (data storage area) BX of the MFP 10. The computer 60 is also referred to as an external device for retrieval or a terminal device for retrieval.

Specifically, as shown in FIG. 1, the MFP 10 stores a plurality of electronic document files (e.g., specific format data files for word processing software, specific format data files for spreadsheet software, or the like) DMi in the box BX thereinside. The electronic document file may be a data file of PDF (Portable Document Format) or the like. Alternatively, the electronic document file may be a PDF data file generated by scanning an original manuscript, or the like.

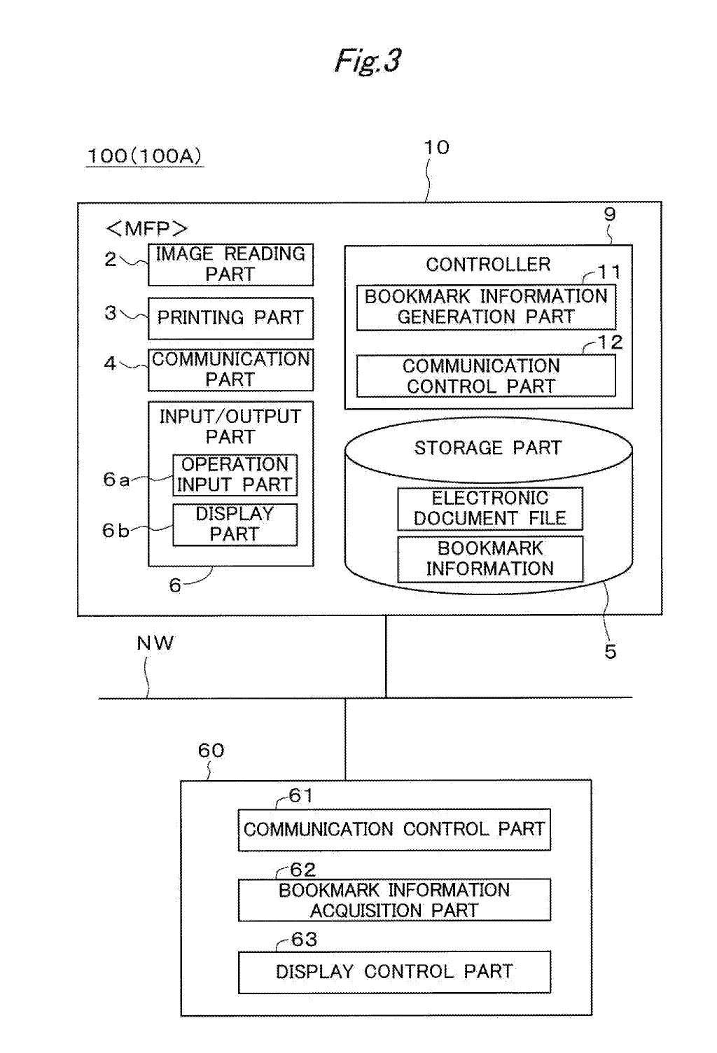

The MFP 10 generates a link information file FSi for each of the electronic document files DMi and stores the link information file FSi thereinside. The MFP 10 further generates an integrated link information file FT by integrating the link information files FSi and stores the integrated link information file FTi thereinside. Each of the link information files FSi and the integrated link information file FT are generated by a bookmark information generation part 11 (see FIG. 3).

In this case, each of the link information files FSi (and the integrated link information file FT) includes link information. The link information is also referred to as “bookmark information”.

The link information (bookmark information) includes item names (in detail, list information of the item names) of items in each of the electronic document files and information about a link target corresponding to each of the items.

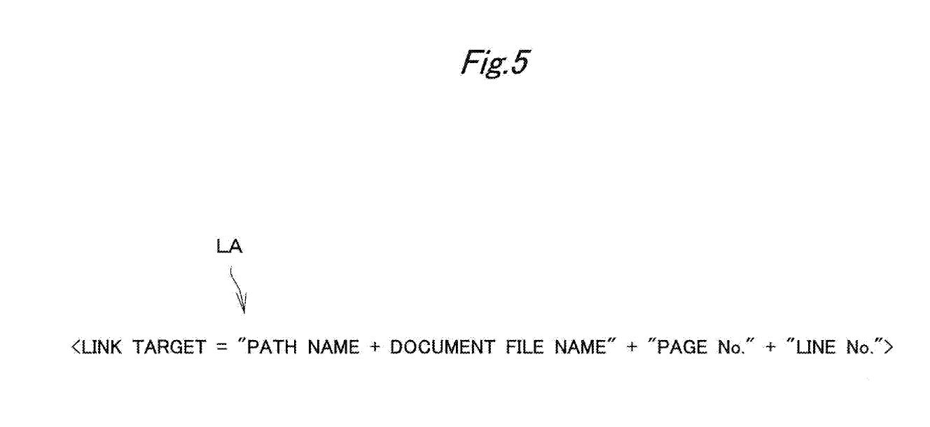

As shown in FIG. 1, for example, an electronic document file DM1 has a plurality of header items (referred to simply as “items”). In more detail, the electronic document file DM1 has items such as “1. Introduction”, “2. Overview of Product XX”, . . . , “5. In Conclusion”, and the like (also see FIG. 2). In this case, a link information file FS1 is generated as information including the list information (item name information) of item names of the plurality of items and information about link targets (link target information LA (see FIG. 5)) corresponding to the plurality of items, respectively.

Similarly, a link information file FS2 is generated as information including the list information (item name information) of item names of the plurality of items in an electronic document file DM2 and information about link targets (link target information) corresponding to the plurality of items, respectively.

Thus, the bookmark information in each of the link information files FSi is generated as information including the list information (item name information) of item names of the plurality of items in the corresponding electronic document file DMi and information about link targets (link target information) corresponding to the plurality of items, respectively.

Further, by integrating these link information files FSi, the integrated link information file FT is generated (see FIG. 1).

As a result, the bookmark information in the integrated link information file FT is generated as information including the list information (item name information) of item names of the plurality of items included in all the electronic document files DM in the box BX and information about link targets (link target information) corresponding to the plurality of items, respectively.

The information included in the link information file FSi is a set of pieces of link information (bookmark information) in a unit of the electronic document file and therefore, is also referred to as “file unit link information” (or “file unit bookmark information”). The information included in the integrated link information file FT is obtained by integrating all pieces of file unit link information and therefore, is also referred to as “integrated link information” (or “integrated bookmark information”).

After that, at an appropriate timing, the integrated link information file FT is transmitted from the MFP 10 to the computer 60. For example, the MFP 10 transmits the integrated link information file FT to a predetermined destination user UA by using an electronic mail (E-mail) ML or the like. Specifically, the integrated link information file FT may be transmitted as an attached file of the E-mail ML.

On the other hand, the destination user UA uses the computer 60 to receive the E-mail ML via the network and displays the content of the E-mail ML on a display part 66b of the computer 60 (see FIG. 2). Then, as discussed later, the destination user UA can retrieve the information of the electronic document file in the MFP 10 by using the received integrated link information file FT, to thereby efficiently access the information. In other words, an operator (destination user UA) of the computer 60 can perform efficient information retrieval.

### 1-2. Constitution of MFP

FIG. 3 is a block diagram schematically showing a constitution of the MFP 10.

As shown in the block diagram of FIG. 3, the MFP 10 comprises an image reading part 2, a printing part 3, a communication part 4, a storage part 5, an input/output part 6, a controller 9, and the like and multiply uses these constituent parts to implement various functions. The MFP 10 is also referred to as an image forming apparatus.

The image reading part 2 is a processing part which optically reads (in other words, scans) the original manuscript placed on a predetermined position of the MFP 10 and generates image data (which is also referred to as an original manuscript image or a scan image) of the original manuscript. The image reading part 2 is also referred to as a scanning part.

The printing part 3 is an output part which prints out an image to various media such as paper on the basis of data on an object to be printed.

The communication part 4 is a processing part capable of performing facsimile communication via public networks or the like. Further, the communication part 4 is capable of performing network communication via the communication network NW. The network communication uses various protocols such as TCP/IP (Transmission Control Protocol/Internet Protocol), FTP (File Transfer Protocol), and the like. By using the network communication, the MFP 10 can transmit and receive various data to/from desired partners. The MFP 10 can also transmit and receive E-mails by using the communication part 4.

The storage part 5 is a storage device such as a hard disk drive (HDD) and the like. The storage part 5 has one or more boxes. Each box is a storage area provided in the MFP 10. In the box, stored are various data files (electronic document files).

The input/output part 6 comprises an operation input part 6a for receiving an input given to the MFP 10 and a display part 6b for performing an display output of various information. Specifically, the MFP 10 is provided with an operation panel 6c (see FIG. 1). The operation panel (touch screen) 6c is a liquid crystal display panel in which a piezoelectric sensor or the like is embedded, serving as part of the display part 6b and also as part of operation input part 6a.

The controller 9 is a control device for generally controlling the MFP 10. The controller 9 is a computer system which is embedded in the MFP 10 and comprises a CPU and various semiconductor memories (RAM, ROM, and the like). The controller 9 causes the CPU to execute a predetermined software program (hereinafter, referred to simply as a “program”) stored in the ROM (e.g., EEPROM or the like), to thereby implement various processing parts. The program may be recorded in various portable (or non-transitory) computer-readable recording medium (e.g., a USB memory and the like) and read out from the recording medium to be installed in the MFP 10. Alternatively, the program may be downloaded via the network or the like to be installed in the MFP 10.

As shown in FIG. 3, the controller 9 implements various processing parts including a bookmark information generation part 11 and a communication control part 12.

The bookmark information generation part 11 is a processing part for generating “bookmark information” on each of the electronic document files in the MFP 10. The bookmark information generation part 11 generates each of the link information files FSi, the integrated link information file FT, and the like.

The communication control part 12 is a processing part for controlling an operation for transmitting the “bookmark information” (specifically, the integrated link information file FT and the like) to the computer 60, and the like operations.

### 1-3. Constitution of Computer (Terminal Device for Retrieval)

The computer 60 is a personal computer or the like comprising a CPU, a RAM, a ROM, and the like. The computer 60 comprises a network communication part, to thereby be capable of performing network communication with other devices (the MFP 10 and the like).

The CPU and the like of the computer 60 executes a predetermined software program (hereinafter, referred to simply as a “program”), to thereby implement various processing parts. Specifically, implemented are various processing parts including a communication control part 61, a bookmark information acquisition part 62, and a display control part 63.

The communication control part 61 is a processing part for controlling an operation for communication with the MFP 10. The communication control part 61 performs an operation for communicating the “bookmark information” to/from the MFP 10.

The bookmark information acquisition part 62 is a processing part for acquiring the “bookmark information” transmitted from the MFP 10. The bookmark information acquisition part 62 acquires the integrated link information file FT and the like.

The display control part 63 is a processing part for controlling a display operation of the display part 66b of the computer 60 (see FIG. 1). The display control part 63 displays the list information based on the acquired “bookmark information”, on the display part 66b, and also displays a result of a search using the list information, and the like, on the display part 66b. Specifically, the display control part 63 uses an operation input part 66a to receive an instruction for display of a specific item in the list information. In response to the display instruction, the display control part 63 acquires information about a link target corresponding to the specific item on the basis of the “bookmark information”, accesses the electronic document file which is the link target, and displays information about the specific item.

### 1-4. Operation for Generating Bookmark Information

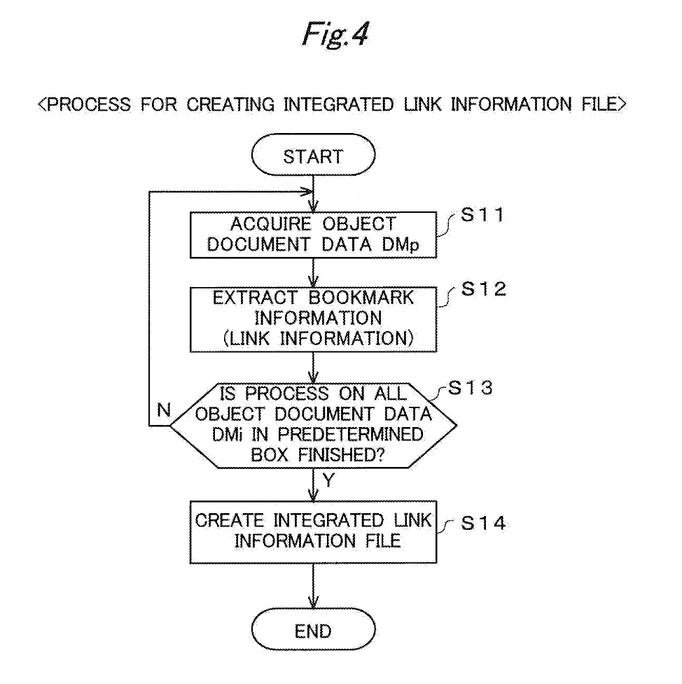

FIG. 4 is a flowchart showing an operation of the MFP 10 for generating the integrated link information file FT. FIG. 5 is a view showing an exemplary specification of a link target of each of the items in the integrated link information file FT. With reference to these figures, discussion will be made on the operation for generating the integrated link information file FT. Herein, the operation will be discussed, taking a case, as an example, where a plurality of link information files FSi are first generated, and after that, the plurality of link information files FSi are integrated into the integrated link information file FT.

In Step S11, first, the MFP 10 specifies an electronic document file DMp to be processed out of a plurality of electronic document files DMi (i=1, . . . , N: the value “N” represents the number of all the electronic document files in a box) stored in a predetermined box (e.g., a user box of the user UA) BX inside the storage part 5.

Then, in Step S12, the bookmark information generation part 11 of the MFP 10 extracts the bookmark information from the electronic document file DMp to be processed.

Specifically, the bookmark information generation part 11 extracts a bookmark item (header item) from character information (character data) in the electronic document file DMp by a predetermined criterion. In more detail, a character string having a predetermined header format is extracted as a character string of the header item. As the character string having a predetermined header format, for example, a character string of a line having numbers (“1.”, “1. 1”, “1. 1. 1”, or the like) at the head of a sentence (at leftmost position) (left-justified character string starting with a number), a character string of one line having a boldface attribute (left-justified character string having a boldface attribute), or the like may be used.

When the operation for extracting such a header item is performed on all the electronic document files DMp, the list information of the item names of a plurality of bookmark items (item list information) is extracted. For example, the item names such as “1. Introduction”, “2. Overview of Product XX”, . . . , “5. In Conclusion”, and the like are extracted.

The bookmark items are extracted, being hierarchized. For example, the item “1. 1 . . . ” is acquired as a lower-hierarchized item of the item “1 . . . . ”, and the item “1. 1. 1 . . . ” is acquired as a further lower-hierarchized item of the item “1. 1 . . . ”,

Though the case where the electronic document file DMi includes character information (character data) is discussed herein, this is only one exemplary case. If the electronic document file DMi includes no character data, for example, the MFP 10 may generate character data by using a character recognition technique. Specifically, the MFP 10 may extract character information included in the electronic document file DMi (scan image or the like) as character data (character code or the like) by using the OCR (Optical Character Reader) technique and further extract the item names or the like by using the extracted character data.

The bookmark information generation part 11 specifies a link target corresponding to each of the bookmark items (in detail, a position where the information corresponding to each of the bookmark items is present) and acquires the information about the link target. Specifically, position information indicating a location (position) where a character string of each of the bookmark items (header items) is placed) is acquired as information LA about the link target corresponding to the header item. As shown in FIG. 5, for a specific bookmark item, a file path name (including address information of the MFP 10) of the electronic document file DMi including the specific bookmark item, a file name of the electronic document file DMi, a page number and a line number in the electronic document file DMi, and the like are acquired as the link target information LA. For the bookmark item “1. Introduction” of the electronic document file DM1, for example, a link position in the electronic document file DM1 (the first line of the first page), as well as the file path on a box BX1 and a file name of the electronic document file DM1, is acquired as the link target information LA. It is preferable that the link target information LA should be unvisualized (being unseen) to accompany the bookmark item.

After that, the bookmark information generation part 11 describes the link target information LA corresponding to each of the bookmark items, being associated with the bookmark item, in the link information file FSp. The information about a jump target corresponding to each of the bookmark items is thereby given to the link information file FSp. In other words, the link for each of the bookmark items is established.

Thus, the “bookmark information” including the list information (item list information) of the item names of a plurality of bookmark items and the information about the link target corresponding to each of the plurality of items (link target information) is acquired and the link information file FSp for the electronic document file DMp is generated.

Such Steps (Steps S11 and S12) as discussed above are repeatedly executed while the electronic document file DMp to be processed is updated. Specifically, these steps are repeatedly executed until it is determined in Step S13 that this operation is completed for all the electronic document files DMi in a predetermined box. As a result, the link information files FSi are generated for all the electronic document files DMi, respectively, in the predetermined box BX.

After that, in Step S14, the integrated link information file FT is generated on the basis of the plurality of link information files FSi. The integrated link information file FT is generated by integrating, for example, three link information files FS1, FS2, and FS3.

The hierarchical structure of the bookmark items and the like in the integrated link information file FT is restructured by using information about the hierarchical structure of the bookmark items. The document name of the electronic document file DMi is described at a level higher than the highest-hierarchized item among the bookmark items of each of the electronic document files DMi.

Specifically, in the integrated link information file FT, the file name of each of the electronic document files DMi is set at the highest level and a content of the corresponding link information file FSi of each of the electronic document files DMi is set at its lower level. In the integrated link information file FT shown in FIG. 1, for example, the file name of the electronic document file DM1 is described at the highest level and the item names, “1. xxx”, “2. xxx”, . . . of the electronic document file DM1 are described at its lower level. Further, the file name of the electronic document file DM2 is described at the highest level and the item names, “1. xxx”, “2. xxx”, . . . of the electronic document file DM2 are described at its lower level.

Thus, the integrated link information file FT is generated, including the bookmark information and the file name of each of the electronic document files DMi which are hierarchized.

As the link target information LA corresponding to each of the items in the integrated link information file FT, information having the same content as that in the corresponding link target information LA of each of the link information file FSi. It is preferable that the link target information LA should be unvisualized (unseen) to accompany the bookmark item. In other words, it is preferable that each link target information LA should be unvisualized when the integrated link information file FT is displayed on the display part 66b. Further, as discussed later, when the operation user UA selects one of the bookmark items in the integrated link information file FT, the position of the link target is specified on the basis of the above link target information LA and the content (information) about the link target of the bookmark item is displayed in accordance with the selecting operation. In other words, an operation of jumping to a corresponding position (line) of a corresponding page in a corresponding file is performed in accordance with the selecting operation.

### 1-5. Operation for Transmitting Bookmark Information

After the integrated link information file FT is thus generated, the MFP 10 transmits the integrated link information file FT to the computer 60 at an appropriate timing.

For example, the MFP 10 has only to transmit the integrated link information file FT to the computer 60 at the time specified by the user UA (at the specified time). Specifically, the user UA sets a time before the estimated time of starting the search of the electronic document files (discussed later) by a predetermined time (about five minutes) as the specified time (set time) in the MFP 10 in advance. Then, in response to the arrival of the specified time, the MFP 10 transmits the integrated link information file FT to the computer 60. The user UA can thereby efficiently acquire the latest integrated link information file FT at the specified time. Then, the user UA can search the electronic document files by using the latest information. In this specifying operation, only the time for one transmission may be specified or the time for a plurality of transmissions may be specified. As the time for a plurality of transmissions, a regular time (once a day, at nine a.m., or the like) may be specified or an irregular time may be specified.

The MFP 10 transmits the integrated link information file FT to a predetermined destination user UA via E-mail ML (see FIG. 1) or the like. For example, the integrated link information file FT is transmitted as an attached file of the E-mail ML.

### 1-6. Operation for Searching Electronic Document File and Operation for Browsing Electronic Document File

On the other hand, the destination user UA uses the computer 60 to receive the E-mail ML via a network and displays the content of the E-mail ML on the display part 66b of the computer 60. Specifically, the destination user UA uses the bookmark information in the received integrated link information file FT to search the electronic document files in the MFP 10 for desired information. In more detail, the destination user UA can browse the item list information (the list information of the item names of the items relating to the electronic document files in the MFP 10) included in the integrated link information file FT and retrieve the desired information. When the desired item in the item list information is selected, the information about the link target of the item is displayed. The operator (destination user UA) of the computer 60 can thereby efficiently retrieve the information stored in the MFP 10.

Hereinafter, such a retrieval operation and the like will be discussed.

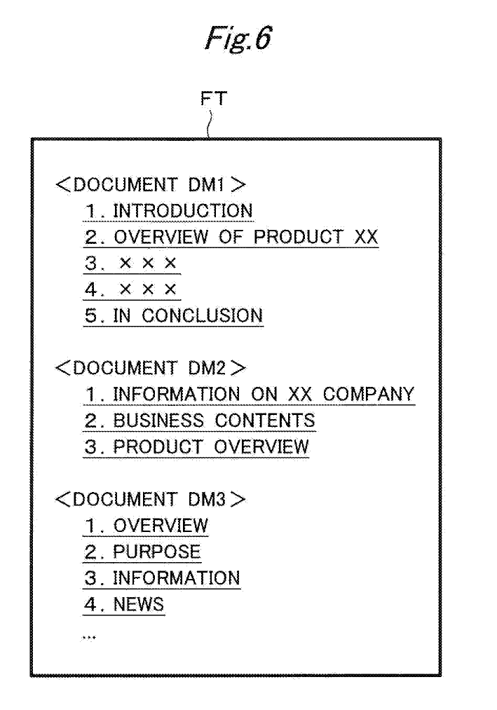

FIG. 6 is a view showing a state where pieces of information in the integrated link information file FT are displayed on the display part 66b of the computer 60 after the integrated link information file FT attached to the E-mail ML is opened by the computer 60.

As shown in FIG. 6, in the integrated link information file FT, displayed are pieces of “bookmark information” (in detail, item names and the like) relating to a plurality of electronic document files DMi, respectively, in a predetermined box of the MFP 10.

With this, since the item names of a plurality of items in one electronic document file DMk are listed, it is possible to efficiently know what information is present in the electronic document file DMk. In more detail, it is possible to roughly know what information is present in the electronic document file DMk. In summary, since the item names in the electronic document file DMk are listed, it is easy for the operation user UA to roughly grasp the information in the electronic document file DMk stored in the MFP 10.

Especially in FIG. 6, since the item names of a plurality of items of a plurality of electronic document files DMi stored in the box BX are listed, it is possible for the operation user UA to efficiently know what information is present in a plurality of electronic document files DM. In summary, since the item names in the electronic document files DMi in the box BX are listed, it is easy for the operation user UA to roughly grasp the information stored in the box BX of the MFP 10. Especially, since the item names of the plurality of items are displayed, being hierarchized, it is possible for the operator to efficiently perform the information retrieval.

Thus, the operation user UA can search the integrated link information file FT for a desired information on the basis of the item names while making a visual check of the item names to know what contents are present in a predetermined box of the MFP 10.

Further, the link of each item name is established, and when a desired item name is clicked by a mouse or the like, a jump operation to the link target corresponding to the item name is performed.

Specifically, an instruction for display of a specific item among a plurality of items in the list information displayed on the display part 66b of the computer 60 is received by the operation input part 66a of the computer 60 and the like. Then, in response to the display instruction for the specific item, the computer 60 acquires the link target information LA corresponding to the specific item on the basis of the integrated link information file FT and accesses the electronic document file which is the link target to display information about the specific item.

In detail, when one bookmark item in the integrated link information file FT is selected, the position of the link target is specified on the basis of the link target information LA corresponding to the bookmark item and the content (information) of the link target of the bookmark item is displayed in accordance with the selecting operation. In more detail, the computer 60 can specify the location (storage location) of the electronic document file DM on the basis of the information about the “file path” and the “file name” in the link target information LA to open the electronic document file DM. The computer 60 can further specify the link target in the electronic document file DMi on the basis of the information about the “page number” and the “line number” described in the link target information LA and display a part corresponding to the item in the electronic document file DM.

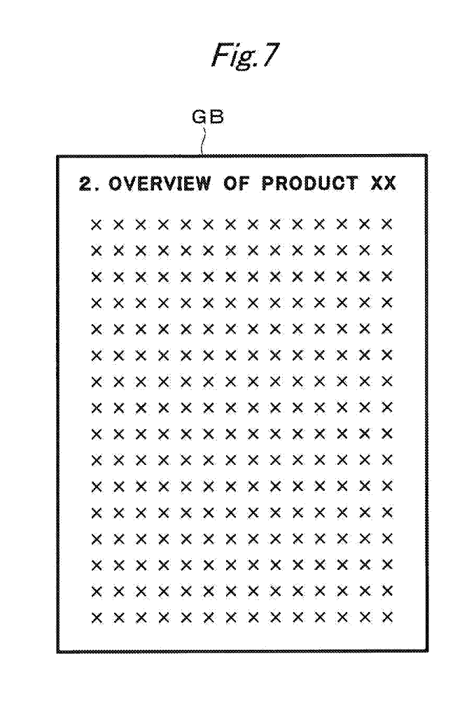

In the integrated link information file FT (FIG. 6), for example, when the bookmark item “2. Overview of Product XX” relating the electronic document file DM1 is clicked by the mouse, the computer 60 accesses the electronic document file DM1 (a file in the box BX of the MFP 10) which is the link target on the basis of the link target information LA corresponding to the bookmark item. Then, the computer 60 displays the information around a predetermined position (e.g., the tenth line of the second page) in the electronic document file DM1 (see FIG. 7). FIG. 7 is a view showing a state where a page including the bookmark item “2. Overview of Product XX” of the electronic document file DM1 is displayed on the display part 66b.

With this operation, the operation user UA can efficiently access the information while browsing the bookmark information.

### 1-7. Variations of the First Preferred Embodiment

In the above-discussed first preferred embodiment, the case has been discussed, where the computer 60 displays the list information on the display part 66b on the basis of the integrated link information file FT received from the MFP 10 and in response to the selection of a specific item in the list information, displays the information of the link target corresponding to the specific item on the display part 66b. The present invention, however, is not limited to this case.

For example, in response to a request from the user of the computer 60, the MFP 10 generates display data for an item selection screen (list information display screen) by using the integrated link information file FT stored inside the MFP 10 and transmits the display data to the computer 60 to cause the item selection screen to be displayed on the display part 66b of the computer 60. In other words, the bookmark information in the integrated link information file FT, being converted into the display data for the item selection screen, may be transmitted to the computer 60. Then, selection of the specific item is performed by using the item selection screen based on the display data and the information acquired in accordance with the selection is displayed on the display part 66b of the computer 60.

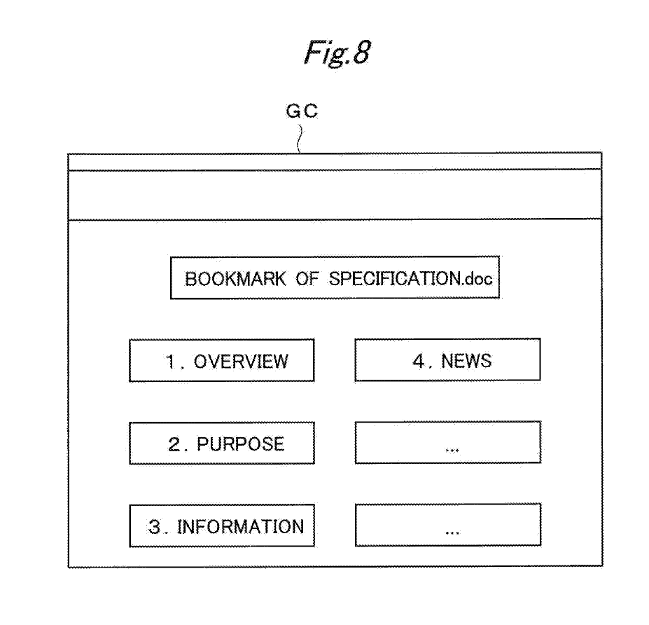

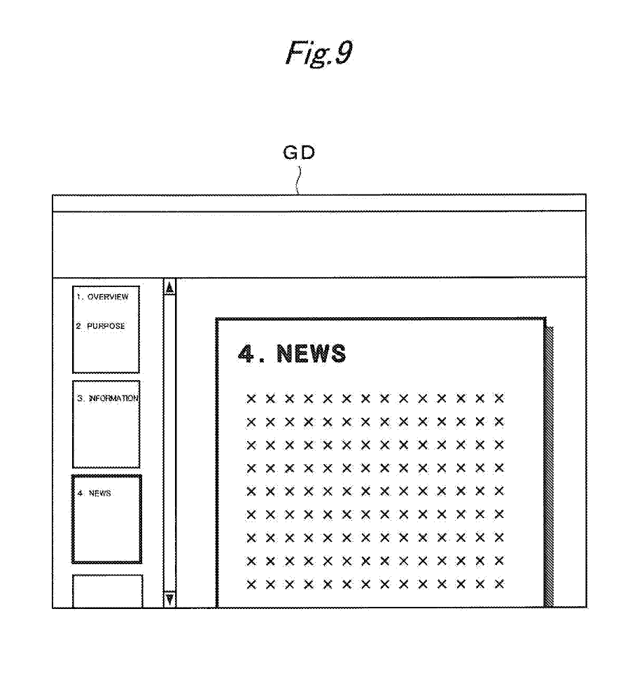

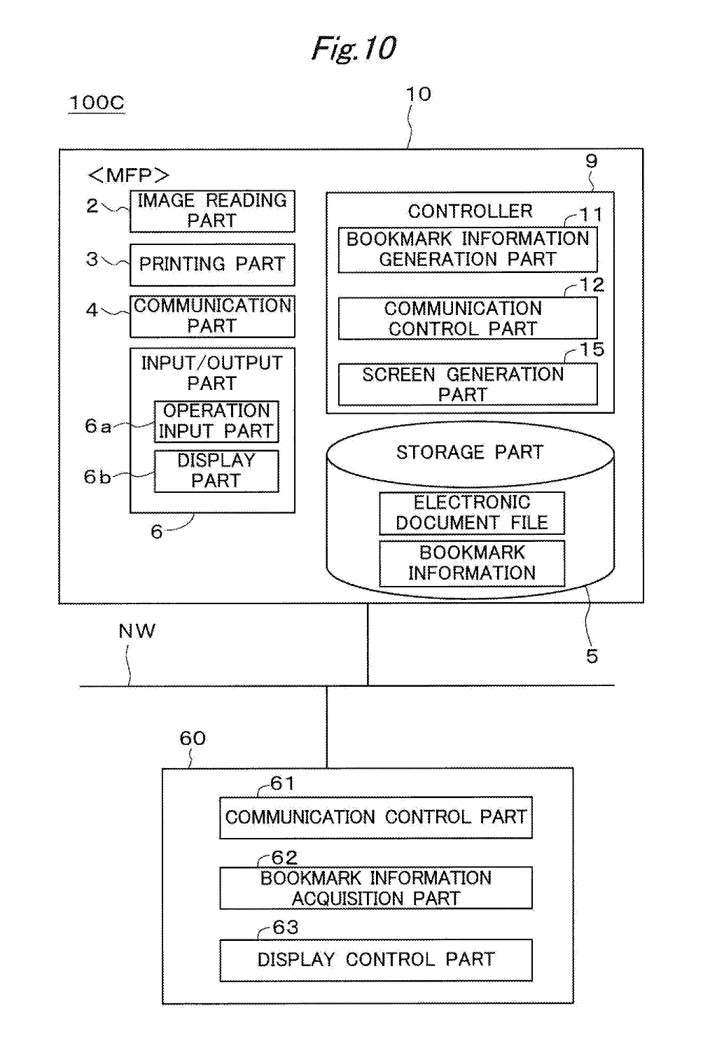

FIGS. 8 to 10 show such an example of variation. FIG. 8 is a view showing an item selection screen GC. FIG. 9 is a view showing a display screen GD displayed on the display part 66b of the computer 60 in response to a result of the selection in the item selection screen GC. FIG. 10 is a view showing a configuration of a system 100 (100C) in accordance with this example of variation.

In this example of variation, the following operation is performed.

First, the operation user of the computer 60 selects an arbitrary item in the document DM3 by using the integrated link information file FT. The computer 60 considers this as a given instruction to display the bookmark information of the document DM3 and transmits the display instruction for the bookmark information of the document DM3 to the MFP 10.

On the other hand, receiving the display instruction, the MFP 10 generates display data for the item selection screen GC (FIG. 8) on the document DM3 (“Specification.doc”) by using the integrated link information file FT stored inside the MFP 10 and transmits the display data to the computer 60. The display data is generated by a screen generation part 15 (see FIG. 10) and transmitted to the computer 60 by the communication control part 12 or the like. Thus, in this example of variation, the selection of an arbitrary item in the document DM3 by the operation user of the computer 60 is regarded as a display instruction for the item selection screen GC on the document DM3, not a display instruction for the item.

Receiving the display data, the computer 60 displays the item selection screen GC on the display part 66b of the computer 60 on the basis of the display data (FIG. 8). In the item selection screen GC, item names of a plurality of items (list information) relating to the electronic document file (DM3) in the MFP 10 are displayed on the basis of the “bookmark information” being converted into the display data. In FIG. 8, displayed are a plurality of items, i.e., “1. Overview”, “2. Purpose”, “3. Information”, “4. News”, and the like relating to the electronic document file DM3.

After that, the same operation as in the first preferred embodiment is performed by using the item selection screen GC.

Specifically, the computer 60 receives a display instruction for a specific item among the plurality of items. In detail, the operation user of the computer 60 selects a desired item (e.g., “4. News”) in the document DM3 among the plurality of items (options) displayed in the item selection screen GC is clicked by a mouse or the like. In response to the selection, the computer 60 considers this as a given instruction to display detailed information about the selected item in the document DM3 and transmits an instruction for display of the specific item (e.g., “4. News” or the like) of the document DM3 to the MFP 10.

In response to the display instruction for the specific item, the MFP 10 transmits the information LA about the link target corresponding to the specific item back to the computer 60 on the basis of the integrated link information file FT inside the MFP 10. On the other hand, the computer 60 accesses the electronic document file which is the link target on the basis of the received information LA and displays the information about the specific item (e.g., “4. News” or the like) (see FIG. 9).

With this operation, the operation user UA can efficiently retrieve the information while browsing the display data generated by the MFP 10, as the “bookmark information”.

Though the case has been discussed herein, where a request for transmission of the display data for the item selection screen GC is sent through the integrated link information file FT received by the computer 60, this is only one exemplary case. The request for transmission of the display data for the item selection screen GC may be sent directly from the computer 60 to the MFP 10, not through the integrated link information file FT. There may be an exemplary case where the request for transmission of the display data for the item selection screen GC on the document DM3 is sent from the computer 60 to the MFP 10 in response to an operation for specifying the document DM3 on the side of the computer 60 (in detail, user's operation of pressing a “bookmark item display button” (not shown) in a predetermined screen to request the display of the “bookmark items” relating to the specific document DM3, or the like). Then, in response to the transmission request, the MFP 10 generates the display data for the item selection screen GC (FIG. 8) on the document DM3 by using the integrated link information file FT stored inside the MFP 10 and transmits the display data to the computer 60, like in the above-discussed operation.

Though the case where the integrated link information file FT is transmitted by using E-mail (via E-mail) has been discussed in the above-discussed first preferred embodiment, this is only one exemplary case. For example, the integrated link information file FT may be transmitted from the MFP 10 to a predetermined folder in the computer 60 by using the network communication via the network. As the network communication, communications using various protocols, such as FTP (File Transfer Protocol) communication, SMB (Server Message Block) communication, and the like may be used.

Though the case where the integrated link information file FT is transmitted has been discussed in the above-discussed first preferred embodiment, this is only one exemplary case. For example, each of the link information files FSi may be individually transmitted. Then, an operation for information retrieval in each of the electronic document files DMi, or the like, may be performed by using the corresponding link information file FSi.

Though the case where the integrated link information file FT is transmitted at the time specified by the user UA has been discussed in the above-discussed first preferred embodiment, this is only one exemplary case.

For example, the updated bookmark information may be transmitted to the computer 60 in synchronization with the timing of updating the file information in a predetermined box of the MFP 10. In detail, the MFP 10 always detects whether the file information in the box BX is updated or not and updates the link information file FSi corresponding to the update file (addition file, change file and/or delete file) when the file information is updated. The MFP 10 further updates the integrated link information file FT by using the updated link information file FSi and immediately transmits the updated integrated link information file FT to the computer 60. With this operation, the user UA can receive the updated bookmark information at each timing of updating the electronic document file in the box. Therefore, it is possible to perform information retrieval on the basis of the latest information.

Alternatively, there may be another case where the user UA uses the computer 60 to transmit a transmission request instruction to the MFP 10 at a desired timing, and the MFP 10 responds to the transmission request instruction from the computer 60 to transmit the integrated link information file FT and the like to the computer 60. In other words, in response to the transmission instruction based on the transmission request operation input by the user of the computer 60, the integrated link information file FT and the like may be transmitted to the computer 60.

Though the case where the integrated link information file FT is transmitted while the electronic document file DMi in the box BX of the MFP 10 is not transmitted to the computer 60 has been discussed in the above-discussed first preferred embodiment, this is only one exemplary case.

For example, when a predetermined condition is satisfied, the electronic document file which is the link target (the electronic document file DMi in a predetermined box of the MFP 10 (strictly speaking, a copy file of the electronic document file DMi)) may also be transmitted together with the integrated link information file FT to the computer 60. Then, by using the link target file (strictly speaking, a copy file of the link target file) and the integrated link information file FT transmitted from the MFP 10, not accessing the electronic document file in the box of the MFP 10, the computer 60 may display the information about a specific item of the electronic document file (copy file). With this operation, since the computer 60 does not need to access the MFP 10 in order to display the information, the computer 60 can immediately display the information.

In more detail, it is preferable that the transmission of the electronic document file to the computer 60 should be permitted when a condition that the amount of data in the electronic document file to be transmitted is smaller than a predetermined threshold value is satisfied. On the other hand, it is preferable that the transmission of the electronic document file to the computer 60 should not be permitted when the amount of data in the electronic document file to be transmitted is larger than the predetermined threshold value. In this case, the computer 60 has only to directly access the electronic document file in the MFP 10 like in the first preferred embodiment.

Further, in these variations, it is preferable that the file path name in the link target information LA of the integrated link information file FT should be changed as appropriate. Specifically, in the link target information LA, it is preferable that the electronic document file stored in a predetermined folder of the destination (a folder of the computer 60) should be specified as the link target. For example, assuming that the electronic document file DMi is transmitted from the MFP 10 to a predetermined folder (destination folder) in the computer 60 via network communication (FTP communication or the like), it is preferable that the following file path name should be set. Specifically, as the file path name in the link target information LA, a file path name of the destination folder (the predetermined folder in the computer 60 which is the destination) has only to be described, instead of the file path name of the MFP 10 which stores the electronic document file DM1.

### 2. The Second Preferred Embodiment

### 2-1. Operation for Retrieving Data in Image Forming Apparatus

In the second preferred embodiment, discussion will be made on a technique for searching for the electronic document file stored in a box of an MFP.

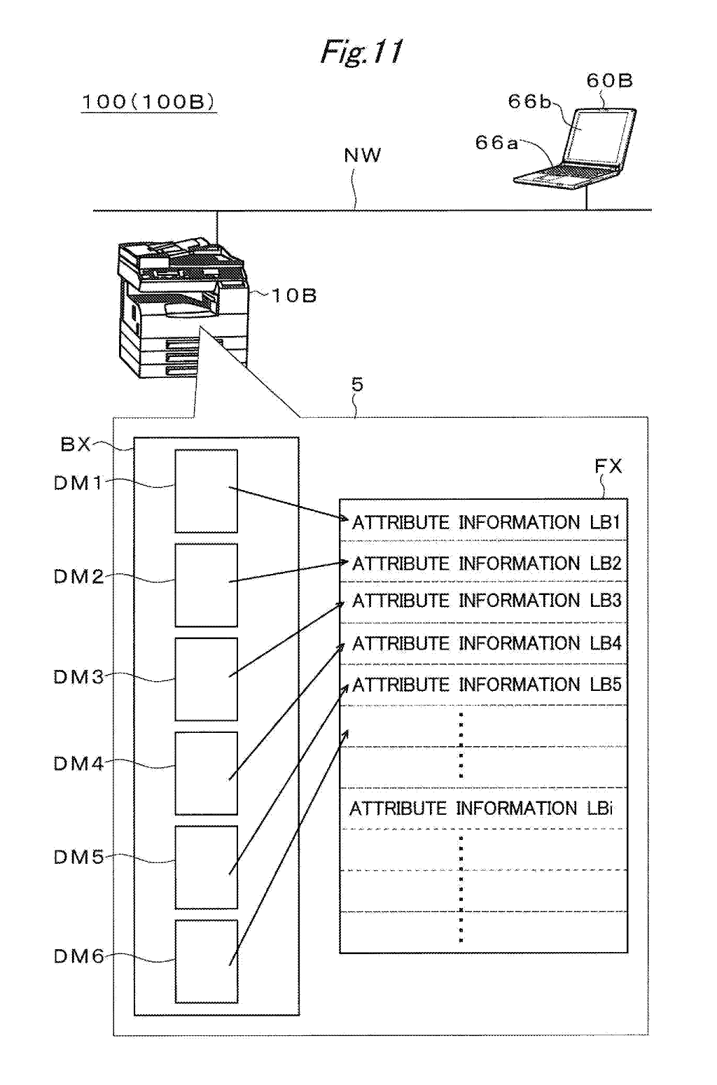

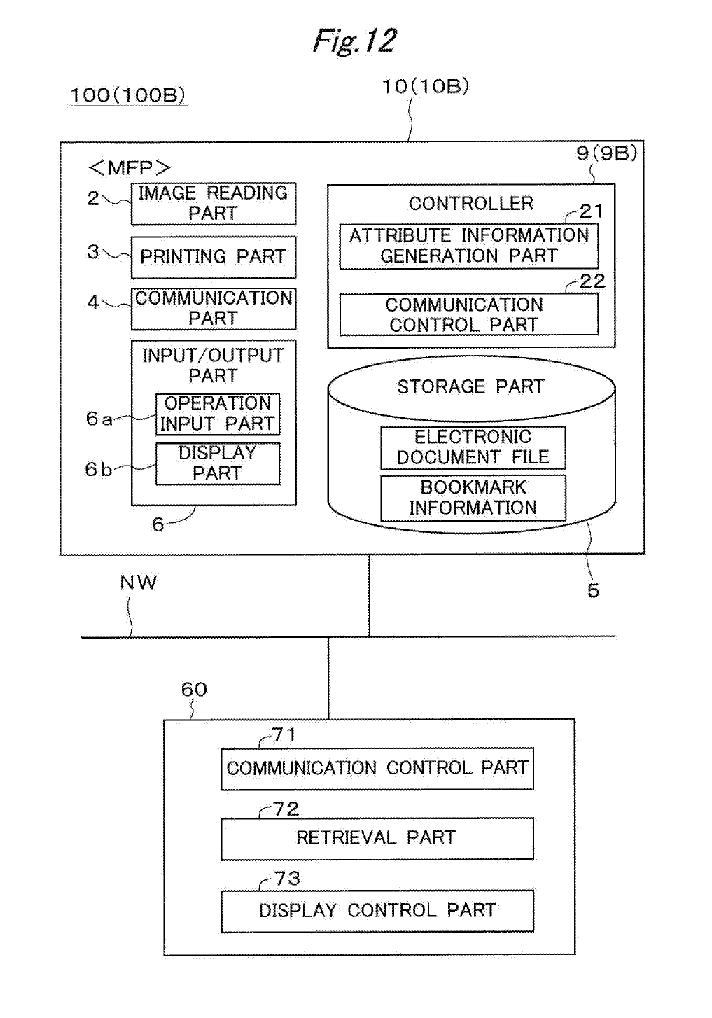

FIG. 11 is a conceptual diagram showing an outline of a retrieval system 100B in accordance with the second preferred embodiment, and FIG. 12 is a block diagram schematically showing a constitution of an MFP (image forming apparatus) 10B in the retrieval system 100B. The retrieval system 100B has a configuration similar to that of the retrieval system 100A of the first preferred embodiment, and constituent parts identical to those of the retrieval system 100A are represented by the same reference signs. Hereafter, discussion will be made centering on the difference between the retrieval system 100A and the retrieval system 100B.

The retrieval system 100B is a system for retrieving information stored in the MFP 10B by using a computer 60B. In detail, the retrieval system 100B is a system for retrieving an electronic document file having a desired attribute out of a plurality of electronic document files stored in a box of the MFP 10B. In the retrieval system 100B, as discussed later, an attribute information file FX which collects pieces of attribute information LBi on the electronic document files DMi in the MFP 10B, respectively, is generated and a search operation (refine search operation) is performed by using the attribute information file FX. This allows an efficient search operation.

As shown in FIG. 12, a controller 9 (9B) of the MFP 10B comprises an attribute information generation part 21 and a communication control part 22.

The attribute information generation part 21 is a processing part for acquiring attribute information LBi of each of the electronic document files DMi in the box of the MFP 10B and generating an attribute information file FX (described later). The communication control part 22 is a processing part for transmitting the attribute information file FX (attribute information) to a terminal device in response to a transmission instruction from the computer 60 (60B).

The computer 60B comprises an operation input part 66a (FIG. 11), a communication control part 71, a retrieval part 72, and a display control part 73. The communication control part 71, the retrieval part 72, and the display control part 73 are processing parts of which the functions are implemented by causing a CPU and the like of the computer 60B to execute a program.

The operation input part 66a is a processing part for receiving an input for specifying a specific attribute which is an attribute of the electronic document file to be extracted.

The communication control part 71 is a processing part for controlling a communication operation with the MFP 10B, and acquires the attribute information (described later) on the electronic document file in the box of the MFP 10B.

The retrieval part 72 is a processing part for performing a retrieval operation to retrieve a desired electronic document file out of a plurality of electronic document files in the box. The retrieval part 72 retrieves an electronic document file having a specified attribute (described later) by using the specified attribute inputted by the operation input part 66a and attribute information acquired by the communication control part 71.

The display control part 73 is a processing part for controlling a display operation in a display part 66b. The display control part 73 controls a display operation to display a search result obtained by the retrieval part 72, on the display part 66b (FIG. 11), or the like.

As shown in FIG. 11, a plurality of electronic document files DM1 to DM6 and the like are stored in a box BX (referred to also as BX1) inside the storage part 5 of the MFP 10B. As each of the plurality of electronic document files, data files of various formats may be used, like in the first preferred embodiment. Hereinafter, discussion will be made on an operation for retrieving an appropriate electronic document file out of a plurality of electronic document files in a single MFP 10B by using the attribute information file FX.

Prior to a search operation, the MFP 10B generates an attribute information file FX which collects pieces of attribute information on the electronic document files DM, respectively.

Hereafter, first, discussion will be made on an operation for generating the attribute information file FX.

The attribute information file FX is generated by the attribute information generation part 21 (FIG. 12). Specifically, the attribute information generation part 21 acquires the pieces of attribute information LBi on the files, respectively, in the box of the MFP 10B to thereby generate the attribute information file FX.

As the attribute information LBi of each of the electronic document file DMi, various pieces of information, such as “file name”, “file format”, “file size”, “file generation time”, “generation user name”, “job type”, and the like are used. The “generation user name” refers to a name of the user who generates the file and the “job type” refers to information indicating the type of job (e.g., a facsimile communication job, a copy job, a scan job, an E-mail transmission job, and the like) which is performed when the file is generated. The “job type” also refers to the type of job which is a cause of the file generation.

The attribute information generation part 21 acquires pieces of attribute information LBi of the electronic document files DMi and generates the attribute information file FX by collecting the pieces of attribute information LBi. The attribute information file FX may be formed as any one of various format files. Herein, a case where the attribute information file FX is formed as a text format file will be discussed.

For example, in the attribute information file FX of text format, the attribute information LBi of each of the electronic document files DM1 is described in one line. Further, in a piece of attribute information LBi, a plurality of types of attributes are described, being separated by single commas (,) or the like.

In detail, the attribute information LB1 of the first electronic document file DM1 is described in the first line of the attribute information file FX, and the attribute information LB2 of the second electronic document file DM2 is described in the second line of the attribute information file FX. Similarly, the attribute information LBi of the i-th electronic document file DMi is described in the i-th line of the attribute information file FX. Further, in the i-th line, a plurality of types of attribute information (“file name”, “file format”, “file size”, “file generation time”, “generation user name”, “job type”, and the like) of the electronic document file DMi are described, being separated by single commas.

The attribute information generation part 21 thus generates the attribute information file FX and stores the attribute information file FX into the storage part 5.

Next, discussion will be made on a search operation using the attribute information file FX.

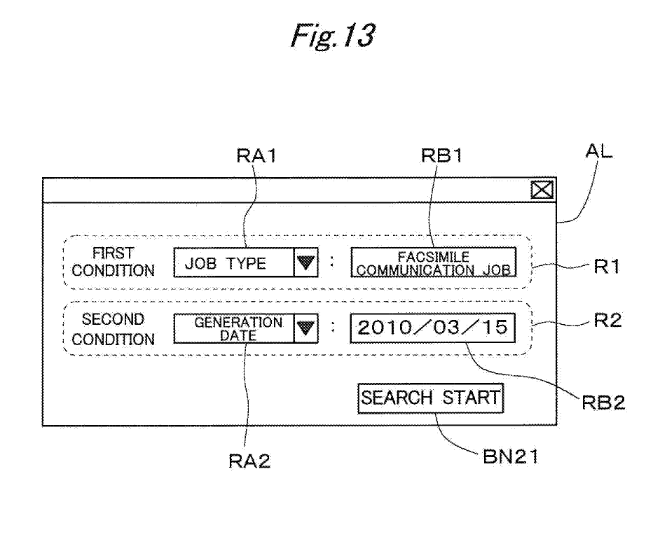

In the computer 60B, it is assumed that a search application software program is in motion and a search dialog AL shown in FIG. 13 is displayed on the display part 66b. Then, by using the search dialog AL, the search operation is performed. In this case, the MFP 10B is set in advance as a device to be searched and a search user UB completes a login operation into the MFP 10B.

The search dialog AL is provided with a first condition specification area R1. The first condition specification area R1 has an attribute type specification field RA1 and an attribute name specification field RB1. In the attribute type specification field RA1, any one of the plurality of types such as “file name”, “file format”, “file size”, “file generation date”, “file generation time”, “generation user name”, “job type”, and the like can be specified. In the attribute name specification field RB1, a specific content (attribute) of the attribute type specified by the attribute type specification field RA1 is specified.

The search dialog AL is further provided with a second condition specification area R2. The second condition specification area R2 has an attribute type specification field RA2 and an attribute name specification field RB2. The attribute type specification field RA2 is the same specification field (input field) as the attribute type specification field RA1 and the attribute name specification field RB2 is the same specification field (input field) as the attribute name specification field RB 1. By using the first condition specification area R1 and the second condition specification area R2, a search operation with a logical product of these two conditions (so called an AND search) can be performed.

By using such a search dialog AL and the operation input part 66a, the operation user UB can specify an attribute of a file to be extracted. In other words, the computer 60B can receive a specification input of the attribute of the file to be extracted by using the operation input part 66a or the like. In FIG. 13, the “job type” is specified in the attribute type specification field RA1 and “facsimile communication job” is specified in the attribute name specification field RB1. Further, the “generation date” is specified in the attribute type specification field RA2 and “2010/03/15” is specified in the attribute name specification field RB2.

When the operation user UB performs such specification inputs and then presses a search start button BN21, the computer 60B performs the following operation.

Specifically, first, the computer 60B sends a transmission instruction which instructs the MFP 10B to transmit the attribute information file FX to itself (the computer 60B), to the MFP 10B.

On the other hand, in response to the transmission instruction from the computer 60B, the MFP 10B transmits the attribute information file FX to the computer 60B.

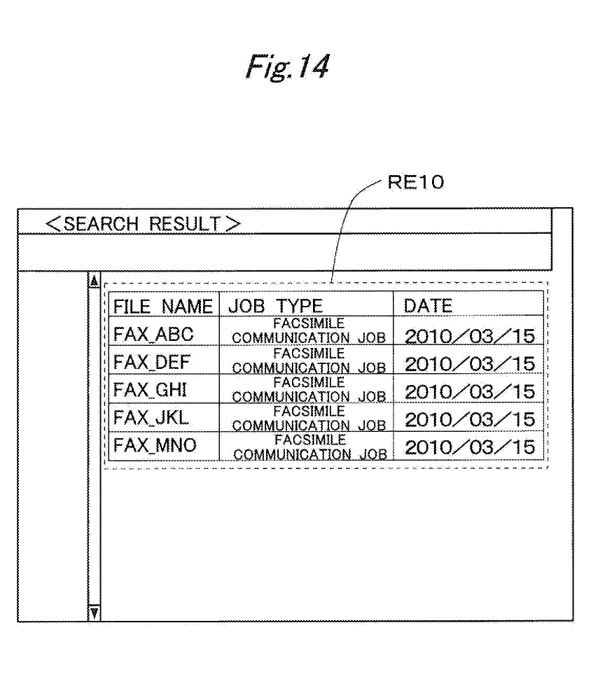

Receiving the attribute information file FX, the computer 60B performs a search operation by using the attribute information file FX. Specifically, the computer 60B performs a search (refine search) for files having the specified attributes among the plurality of electronic document files in the box BX by using the attribute information file FX transmitted from the MFP 10B and the specified attributes (“facsimile communication job” and “2010/03/15”) inputted by the operation input part 66a or the like. Then, the computer 60B displays a search result on the display part 66b (see FIG. 14).

FIG. 14 shows a result RE1 of the search operation to extract the electronic document files which are generated on “2010/03/15” by the “facsimile communication job” out of the plurality of electronic document files in the box BX of the MFP 10B.

In the above-discussed method, it is possible to appropriately extract the electronic document files having the specific attributes specified by the user by using the attribute information file FX which collects the pieces of attribute information of the electronic document files DM in the box BX of the MFP 10B. Therefore, a more efficient search operation can be performed. Especially, since the search operation based on the attribute information specific to the MFP 10B (“generation user name”, “job type”, and the like) is performed, a more useful search operation can be performed.

### 2-2. Operation for Retrieving Data in Image Forming Apparatuses

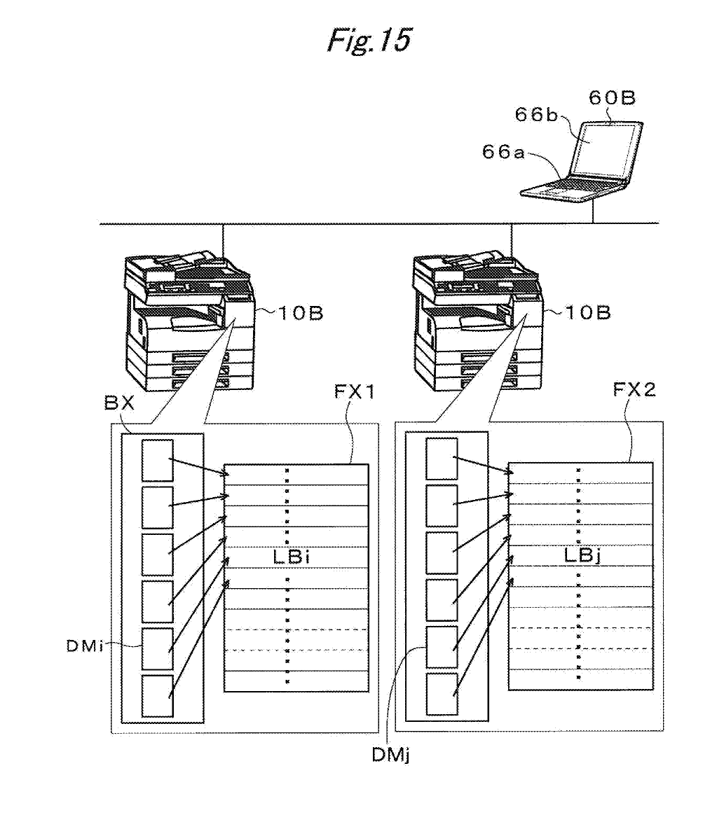

Though the case where a search for data is performed in a single MFP (image forming apparatus) 10B has been discussed above, this is only one exemplary case. Hereafter, a case where a search for data is performed in a plurality of MFPs 10B will be discussed (see FIG. 15).

Also in this case, a search operation is performed by using the search dialog AL (FIG. 13). In this case, however, it is assumed that a plurality of (two) MFPs 10B are set in advance as devices to be searched by using another setting screen (not shown) and the search user UB completes a login operation into each of the plurality of MFPs 10B. The computer 60B and the plurality of MFPs 10B are connected to one another via a network, and network communication can be established therebetween.

Further, it is assumed that an attribute information file FX (FX1) is generated and stored in one of the MFPs 10B and an attribute information file FX (FX2) is generated and stored in the other MFP 10B. The attribute information file FX2 is a file which collects pieces of attribute information on a plurality of electronic document files DMj stored in a box BX (BX2) of the other MFP 10B.

Like in the above-discussed method, the operation user UB performs specification inputs by using the search dialog AL or the like and then presses the search start button BN21, the computer 60B performs the following operation.

Specifically, first, the computer 60B sends a transmission instruction which instructs each of the plurality of (herein, two) MFPs 10B to transmit the attribute information file FX to itself (the computer 60B), to each of the MFPs 10B.

On the other hand, in response to the transmission instruction from the computer 60B, each of the MFPs 10B transmits the attribute information file FX (in detail, FX1 or FX2) to the computer 60B. Specifically, one of the MFPs 10B transmits the attribute information file FX1 to the computer 60B and the other MFP 10B transmits the attribute information file FX2 to the computer 60B.

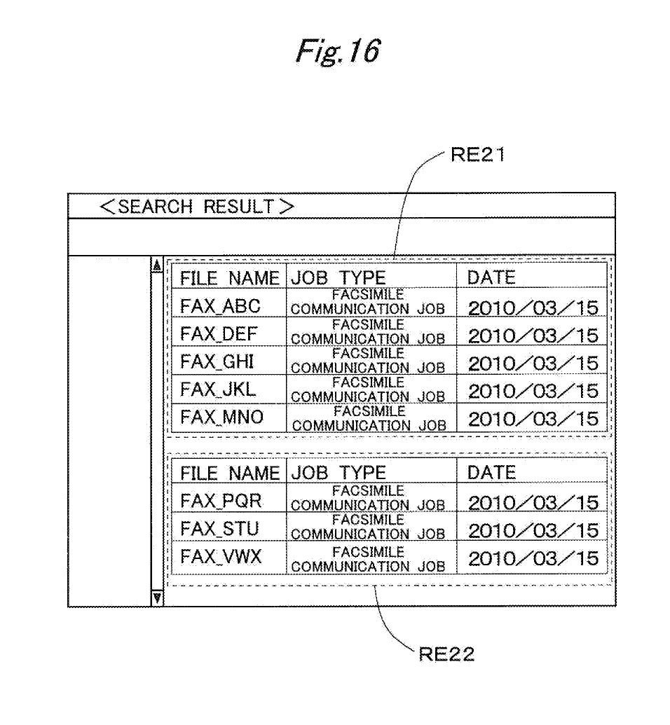

Receiving the attribute information files FX (FX1 and FX2) from the respective MFPs 10B, the computer 60B performs a search operation by using the attribute information files FX (FX1 and FX2). Specifically, the computer 60B performs a search for files having the specified attributes among the plurality of electronic document files stored in the respective boxes BX (BX1 and BX2) of the plurality of MFPs 10B by using the attribute information files FX1 and FX2 transmitted from the two MFPs 10B and the specified attributes (“facsimile communication job” and “2010/03/15”) inputted by the operation input part 66a or the like. Then, the computer 60B displays a search result on the display part 66b (see FIG. 16).

FIG. 16 shows a result of the search operation to extract the electronic document files which are generated on “2010/03/15” by the “facsimile communication job” out of the plurality of electronic document files in the boxes BX1 and BX2. In detail, a search result RE21 on the box BX1 of one of the MFPs 10B is displayed on the upper side in the screen and a search result RE22 on the box BX2 of the other MFP 10B is displayed on the lower side in the screen.

Thus, in the above-discussed method, it is possible to appropriately extract the electronic document files having the specific attributes specified by the user by using the attribute information files FX1 and FX2 which collect the pieces of attribute information of the electronic document files DM in the boxes BX of the plurality of MFPs 10B. Therefore, a more efficient search operation can be performed. Especially, since the search operation based on the attribute information specific to the MFPs 10B (“generation user name”, “job type”, and the like) is performed, a more useful search operation can be performed. Further, since the search through the plurality of MFPs 10B is performed in response to one instruction for search start and the search results are displayed, being listed, a more efficient search operation can be achieved.

Though the case where the search through two MFPs 10B is performed has been discussed herein, this is only one exemplary case. A search through three or more MFPs 10B can be performed.

### 2-3. Variations of The Second Preferred Embodiment

Though the case where the “AND search” based on two conditions is performed has been discussed in the above-discussed second preferred embodiment, this is only one exemplary case. An “AND search” based on three or more conditions, for example, may be performed. Alternatively, a search based on only a single condition may be performed.

Further, instead of the “AND search”, an “OR search” (a search with a logical sum of a plurality of conditions) based on a plurality of conditions may be performed. Moreover, a combination of the “AND search” and the “OR search” may be performed.

While the invention has been shown and described in detail, the foregoing description is in all aspects illustrative and not restrictive. It is therefore understood that numerous modifications and variations can be devised without departing from the scope of the invention.

What is claimed is:

1. A retrieval system for retrieving information stored in an image forming apparatus, comprising:
an image forming apparatus having a box which is a data storage area; and
a terminal device for retrieval, which is connected to said image forming apparatus via a network,
wherein said image forming apparatus has
a storage part for storing bookmark information including list information of item names of items in an electronic document file stored in said box; and
a transmission part for transmitting said bookmark information to said terminal device.

2. The retrieval system according to claim 1, wherein
said bookmark information includes said list information on each of a plurality of electronic document files stored in said box.

3. The retrieval system according to claim 1, wherein
said bookmark information further includes information about a link target corresponding to each item in said electronic document file stored in said box.

4. The retrieval system according to claim 1, wherein
said bookmark information includes said list information on each of a plurality of electronic document files stored in said box and information about a link target corresponding to each item in each of said plurality of electronic document files.

5. The retrieval system according to claim 1, wherein
said image forming apparatus further has a bookmark information generation part for generating said bookmark information by extracting item information in said electronic document file.

6. The retrieval system according to claim 5, wherein
said bookmark information generation part generates file unit bookmark information including said list information on each of a plurality of electronic document files stored in said box, for each of said plurality of electronic document files, and generates integrated bookmark information, as said bookmark information, in which a plurality of pieces of file unit bookmark information generated for said plurality of electronic document files are integrated.

7. The retrieval system according to claim 5, wherein
said bookmark information generation part generates file unit link information on said list information of item names of items in each of a plurality of electronic document files and information about a link target corresponding to each item in each of said plurality of electronic document files, for each of said plurality of electronic document files stored in said box, and generates integrated link information, as said bookmark information, in which a plurality of pieces of file unit link information generated for said plurality of electronic document files are integrated.

8. The retrieval system according to claim 1, wherein
said terminal device has
an acquisition part for acquiring said bookmark information transmitted from said image forming apparatus, and
a display control part for displaying said list information included in said bookmark information acquired by said acquisition part.

9. The retrieval system according to claim 3, wherein
said terminal device has
an acquisition part for acquiring said bookmark information transmitted from said image forming apparatus, and
a display control part for displaying said list information included in said bookmark information acquired by said acquisition part,
and wherein said display control part displays item names of a plurality of items relating to said electronic document file on the basis of said bookmark information, to thereby receive a display instruction for a specific item out of said plurality of items, and
displays information on said specific item acquired by accessing an electronic document file which is said link target, on the basis of information about a link target corresponding to said specific item in response to said display instruction.

10. The retrieval system according to claim 1, wherein
said transmission part transmits said bookmark information to said terminal device via E-mail transmission.

11. The retrieval system according to claim 1, wherein
said transmission part transmits said bookmark information to a predetermined folder of said terminal device via network communication.

12. The retrieval system according to claim 1, wherein
said image forming apparatus further has
a screen generation part for generating display data for an item selection screen used for selecting a desired item out of a plurality of items in said electronic document file, on the basis of said bookmark information, and
said transmission part transmits said bookmark information which is converted into said display data to said terminal device.

13. The retrieval system according to claim 1, wherein
said transmission part transmits said bookmark information after being updated to said terminal device, in synchronization with an update timing of file information in said box.

14. The retrieval system according to claim 1, wherein
said transmission part transmits said bookmark information to said terminal device at a specified time which is set in advance.

15. The retrieval system according to claim 1, wherein
said transmission part transmits said bookmark information to said terminal device in response to a transmission instruction based on an transmission request operation input by a user of said terminal device.

16. The retrieval system according to claim 9, wherein
said transmission part transmits a copy file of said electronic document file together with said bookmark information when a predetermined condition is satisfied, and
said display control part displays information about said specific item acquired by accessing said copy file in response to said display instruction.

17. An image forming apparatus connected to an external device for retrieval via a network, comprising:
a storage part having a box which is a storage area for an electronic document file;
a generation part for generating bookmark information including list information of item names of items in said electronic document file; and
a transmission part for transmitting said bookmark information to said external device.

18. A non-transitory computer-readable recording medium for recording a computer program to be executed by a computer embedded in an image forming apparatus to cause said computer to perform the steps of:
a) generating bookmark information including list information of item names of items in an electronic document file stored in a box which is a storage area inside said image forming apparatus; and
b) transmitting said bookmark information to an external device for retrieval via a network.

19. A retrieval system for retrieving information stored in an image forming apparatus, comprising:
an image forming apparatus which stores information in a box which is a storage area thereinside; and
a terminal device for retrieval, which is connected to said image forming apparatus via a network,
wherein said image forming apparatus has
an attribute information acquisition part for acquiring attribute information of each file in said box; and
a transmission part for transmitting said attribute information of said each file to said terminal device in response to a transmission instruction from said terminal device, and
said terminal device has
an input part for receiving a specification input of a specific attribute which is an attribute of a file to be extracted; and
a retrieval part for retrieving a file having said specific attribute among a plurality of files in said box on the basis of said attribute information transmitted from said image forming apparatus and said specific attribute inputted by said input part.

20. A retrieval system for retrieving information stored in an image forming apparatus, comprising:
a plurality of image forming apparatuses; and
a terminal device for retrieval, which is connected to said plurality of image forming apparatuses via a network,
wherein said plurality of image forming apparatuses each have
a storage part having a box which is a file storage area;
an attribute information acquisition part for acquiring attribute information of each file in said box; and
a transmission part for transmitting said attribute information of said each file to said terminal device in response to a transmission instruction from said terminal device, and
said terminal device has
an input part for receiving a specification input of a specific attribute which is an attribute of a file to be extracted; and
a retrieval part for retrieving a file having said specific attribute among a plurality of files in said box on the basis of said attribute information transmitted from each of said plurality of image forming apparatuses and said specific attribute inputted by said input part.
